(19) United States
(12) Patent Application Publication
(10) Pub. No.: US 2009/0172639 A1
(43) Pub. Date: Jul. 2, 2009

(54) FIRMWARE INTEGRITY VERIFICATION

(76) Inventors: Mahesh Natu, Portland, OR (US); Sham Datta, Hillsboro, OR (US); Ernie Brickell, Portland, OR (US)

Correspondence Address: INTEL CORPORATION;c/o CPA Global, P.O. BOX 52050, MINNEAPOLIS, MN, 55402, US

(21) Appl. No.: 11/965,295

(22) Filed: Dec. 27, 2007

(51) Int. Cl. G06F 9/44

(52) U.S. Cl. 717/120

(57) ABSTRACT

In some embodiments, the integrity of firmware stored in a non-volatile memory is verified prior to initiation of a firmware reset vector. Other embodiments are described and claimed.

### RELATED APPLICATIONS

This application is related to U.S. patent application Ser. No. 11/355,697 entitled “Technique for Providing Secure Firmware” filed on Feb. 15, 2006.

This application is also related to U.S. patent application Ser. No. 11/863,563 entitled “Supporting Advanced RAS Features in a Secured Computing System” filed on Sep. 28, 2007.

### TECHNICAL FIELD

The inventions generally relate to firmware integrity verification.

### BACKGROUND

Intel® trusted execution technology for safer computing, code named LaGrande Technology (LT), is a versatile set of hardware extensions to Intel® processors and chipsets that enhances any personal computer (PC) platform (for example, the digital office platform) with security capabilities such as measured launch and protected execution. LT is a component of the Intel safer computing initiative, and was first introduced in client platforms. Intel trusted execution technology provides hardware-based mechanisms that help protect against software-based attacks and protects the confidentiality and integrity of data (for example, passwords, keys, etc.) stored or created on a personal computer (PC).

Better protection is achieved by enabling an environment where applications can run within their own space, protected from all other software on the system. These capabilities provide the protection mechanisms, rooted in hardware, that are necessary to provide trust in the application's execution environment and help protect vital data and processes from being compromised by malicious software running on a platform.

In Intel trusted execution technology control flow, a VMM (Virtual Machine Monitor) loader launches an Intel signed module which is presented with the cryptographic measurement of the platform firmware code (and/or platform Basic Input/Output System code and/or platform BIOS code). This module contains what is known as a launch control policy (LCP) engine. This policy engine compares this measurement with what is recorded in a policy data structure and communicates to the VMM the security “goodness” of the BIOS firmware. The VMM gets to choose whether to trust the measured platform BIOS code or not. If it trusts the BIOS code, it will launch a secure environment. In this case, the VMM can place secrets in memory and uses Intel Virtualization Technologies to prevent unauthorized accesses to these secrets. Secrets may include items such as passwords, private keys, personal information, etc. However, the inventors have recognized a need for ensuring that the BIOS policies themselves have not been compromised by malicious software.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a computing system according to some embodiments of the inventions.

FIG. 2 illustrates a data structure according to some embodiments of the inventions.

FIG. 3 illustrates a flow according to some embodiments of the inventions.

### DETAILED DESCRIPTION

Some embodiments of the inventions relate to firmware integrity verification.

In some embodiments, the integrity of firmware stored in a non-volatile memory is verified prior to initiation of a firmware reset vector. A processor initiates a code module (for example, an Intel signed code module) to verify integrity of the firmware prior to initiation of a firmware reset vector.

In some embodiments a non-volatile memory stores a firmware policy. A processor initiates a code module (for example, an Intel signed code module) to verify integrity of the firmware policy prior to initiation of a firmware reset vector.

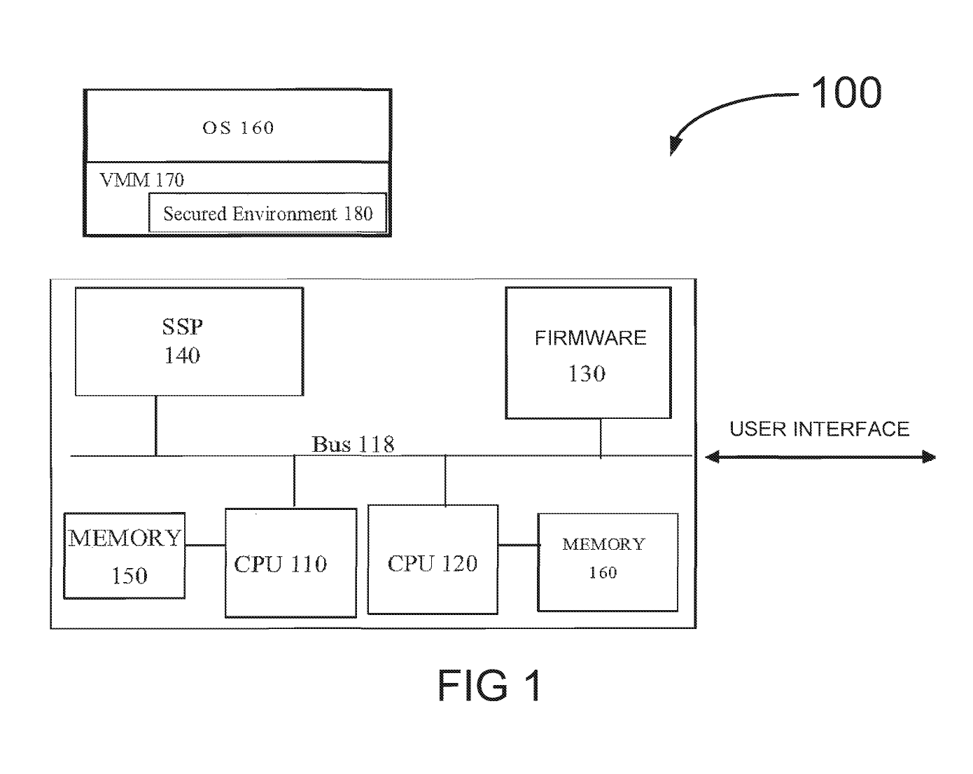

FIG. 1 illustrates a computing system 100 according to some embodiments. Computing system 100 may include in some embodiments one or more central processing unit (CPU) 110 and/or CPU 120 that is coupled to firmware (for example, a BIOS and/or a platform BIOS) 130, a system service processor (SSP) 140, memory 150 by way of bus 118. While two CPUs 110 and 120 are illustrated in FIG. 1 it is noted that any number of one or more CPUs may be used in some embodiments. In some embodiments CPU 110, CPU 120, and/or memory 160 may be hot plugged. Firmware 130 is a logic code that is executed during a startup of computing system 100 that recognizes and controls various system components. SSP 140 comprises hardware and software components needed to monitor and control a platform of computing system 100. In some embodiments, SSP 140 may operate independently from CPU 110, CPU 120, and/or VMM 170.

Memory 150 may comprise local memory, bulk storage, cache memory or any type of volatile and/or non-volatile type of storage medium suitable for storing data. CPUs 110, 120 are components of computing system 100 that are capable of executing program code (for example, authenticated code modules or ACMs, microcode, application software, etc.) Bus 118 is a subsystem that transfers data or power between various components of computing system 100.

In some embodiments, a secured computing environment may be implemented by way of employing a virtual machine monitor (VMM) 170 configured to launch and maintain a secure environment 180. VMM 170 controls and manages the hardware and software resources of computing system 100. One or more operating systems (for example, OS 160) can be running on top of VMM 170. VMM 170 may be configured to protect confidential information stored in computing system 100 by implementing secured environment 180. In some embodiments, secure environment 180 may be supported by trusted execution technology such as an Intel® trusted execution technology (for example, LT).

It is noteworthy that certain features and aspects of the invention are disclosed herein by way of example with reference to and as applicable in part to Intel® trusted execution technology and/or LT. It should be emphasized, however, that the scope of the invention should not be construed as limited to such exemplary embodiments or in particular to secure environments implemented exclusively under Intel® trusted execution technology and/or LT. As such, the principals, features and advantages provided herein may be implemented to work with or apply to any secured or trusted computing environments.

In some embodiments, for example, additional capabilities are added to the trusted execution technology described above (for example, in a server version of Intel® trusted execution technology). Some versions can be implemented that use a security model that allows RAS (Reliability, Availability, and Serviceability) features to coexist with security. Thus, some of the system firmware is allowed to be within the trust boundary after measurement. In some embodiments using trusted execution technology, a capability is included that uses a signed code module (for example, an authenticated code module and/or an Intel signed code module referred to as Startup authenticated code module or Startup ACM) to be launched prior to invoking a firmware reset vector (for example, BIOS reset vector). In this type of environment, four situations exist in which a signed code module needs to decide whether or not the firmware (BIOS) image in the firmware flash device can be trusted or not, which include wiping secrets from memory, an S3 resume, some large systems including node controller based systems, and a CPU hot add.

When wiping secrets from memory using trusted execution technology, a signed code module is used to clean the leftover secrets from memory, before letting any un-trusted code module to run. However, this solution does not scale well to complex memory technologies (for example, Fully Buffered DIMM (FBD) based memory systems that may be found in server platforms). Therefore, for this functionality of wiping secrets, for example, in some embodiments the trusted execution technology relies on firmware (for example, BIOS firmware code) which already knows how to configure memory on the given platform. Prior to handling control to the firmware, the signed code module must make sure that the firmware (for example, BIOS) can be trusted with the secrets.

In some embodiments, before entering a low power state (for example, a low power Advanced Configuration and Power Interface defined or ACPI defined S3 state), the trusted execution technology based system does not require a full teardown of the secure environment. Therefore, upon a low power state resume such as an S3 resume, for example, when resuming from the low power state the memory will have secrets contained therein since S3 involves a CPU reset. Therefore, control flow of an S3 resume which will go through a signed code module (for example, Startup ACM), and the firmware (BIOS) code. The signed code module must make sure that the firmware can be trusted with the secrets during the S3 resume path.

In some large systems including node controller based systems, platform firmware (for example, BIOS) code must be used to configure the basic hardware elements (or the interconnect that binds them) that are involved in making up of the computing platform that deals with secret data. In such embodiments of trusted execution technology, the signed code module that runs prior to handing control to a reset vector (like the Startup ACM) needs to make sure that the firmware (for example, BIOS) is trusted to perform these basic hardware configuration activities.

In some embodiments, trusted execution technology requires that a portion of firmware (for example, in some embodiments, BIOS) be brought into the trust domain well ahead of VMM launch. This may be necessary in complex, multi-node platforms where a portion of the firmware (for example, the BIOS) can be used to configure trusted execution technology hardware elements. A signed code module (for example, Startup ACM) must make sure that the firmware (BIOS) can be trusted to perform these activities. In some embodiments, therefore, a code module is to verify the integrity when the firmware is brought into a trust domain so as to configure trusted execution technology hardware.

In some embodiments trusted execution technology allows addition of a CPU (that is, CPU hot add) after the secure environment has been launched. A CPU that has been newly added to such a system will execute firmware (for example, BIOS) code. While the new CPU is running the firmware code, the firmware has full access to system memory resources and secrets. Therefore, the signed code module (for example, Startup ACM) must make sure that the firmware (for example, BIOS) is trusted not to leak secrets before handling control.

In some embodiments the signed code module does not have inherent knowledge of which firmware (for example, BIOS) measurements are good and which ones are not good. Therefore, the signed code module must rely on one or more external policy stored in non-volatile memory. In some embodiments, these external policies are referred to as firmware policies. In some embodiments these external policies are referred to as BIOS policies.

In some embodiments the signed code module (for example, Startup ACM) uses a hardware module (for example, a trusted platform module or TPM) to store part of the policy data securely. This is similar, for example, to a launch control policy (LCP) mechanism implemented by Intel® trusted execution technology for verifying whether the VMM can be trusted or not.

In some embodiments the signed code module (for example, Startup ACM) needs some cryptographic mechanism to ensure that the firmware policies (for example, the BIOS policies) themselves are not compromised by malicious software, for example. A good way to achieve this would be for the Original Equipment Manufacturer (OEM) of the computing system to digitally sign the firmware policy (for example, the BIOS policy). However, many OEMs do not have the ability to and/or do not wish to digitally sign firmware policies (for example, BIOS policies), due to cost and logistical reasons. In some embodiments cryptographic mechanisms are implemented for ensuring that the firmware policies themselves are not compromised (for example, by malicious software). In some embodiments a hash based method and/or a signature based method may be used to ensure that the firmware policies are not compromised.

In some embodiments a hash based method may be used to ensure that the firmware policies (for example, BIOS policies) are not compromised. In some embodiments the signed code module (for example, Startup ACM) computes the cryptographic hash of the firmware module (for example, BIOS module) and compares it with a known good hash (for example, from a previous known good boot) to make the trust decision. In some embodiments, one or more of at least two different models are used to support various firmware update models (for example, BIOS update models) that are prevalent in the server market. These include at least an automatic promotion model and a golden firmware image model (for example, a golden BIOS image model).

In some embodiments, an automatic protection model is a hash based method that allows OEMs to obtain trusted execution technology capabilities (for example, for servers) without any effort by the OEM. The firmware update utility (for example, BIOS update utility) of the OEM is not aware of the firmware policy and makes no effort and/or cannot possibly make any effort to keep it in sync when the firmware is updated. In the automatic promotion model the signed code module (for example, ACM and/or Startup ACM) first measures and saves the firmware hash (for example, BIOS hash) into the TPM during every boot operation and stores the measured and saved firmware hash (for example, as “value A”). Then, if the signed code module encounters a situation such as, for example, wiping secrets from memory, an S3 resume, and/or a CPU hot add, it is an indication that the VMM made a decision to trust the firmware (for example, the BIOS) whose measurement was “value A” and placed secrets in memory during the previous boot session. The signed code module (for example, Startup ACM) uses this logic to establish trust in the firmware (for example, BIOS) whose hash is “value A”. The signed code module can trust this firmware and proceed with the firmware code.

In some embodiments a golden firmware image model (for example, a golden BIOS image model) is a hash method that allows OEMs to obtain trusted execution technology capabilities (for example, for servers) without any effort by the OEM. In some embodiments computing platforms support a golden firmware image model in which the OEM installs two firmware images in the factory, including an active firmware image and a backup firmware image. In some embodiments the backup image may be a complete firmware image (for example, complete BIOS image) or a partial firmware image (for example, partial BIOS image). The backup image is rarely updated in the field and gets used if any damage were to happen to the active firmware image. In some embodiments the OEM installs a measurement of the golden firmware into a one time writeable TPM storage. The signed code module (for example, ACM and/or Startup ACM) checks if the golden measurement is provided. If the golden measurement matches the firmware then the firmware that matches the golden measurement is considered to be trusted.

In some embodiments a signature based method may be used to ensure that the firmware policies (for example, BIOS policies) are not compromised. In some embodiments a signature based method is a very flexible method and provides seamless firmware updates (for example, BIOS updates). In some embodiments and OEM uses a private key to sign the expected hash value. A public key to sign the expected hash value as well as the expected hash value are included in the firmware (for example, included in the BIOS) and are updated when the firmware is updated. In some embodiments the hash of the public key is stored in the TPM.

In some embodiments specific capabilities may be added to the signed code module (for example, the ACM and/or Startup ACM) in order to enable implementations according to some embodiments. For example, such capabilities may be built on top of a hardware based root of trust such as a Firmware Interface Table (FIT) based boot capability. Related information describing such FIT based boot capabilities is described in related U.S. patent application Ser. No. 11/355,697 entitled “Technique for Providing Secure Firmware” filed on Feb. 15, 2006.

In some embodiments, in order to support specific capabilities relating to a situation where a signed code module (for example, ACM and/or Startup ACM) needs to decide whether or not the firmware image can be trusted, changes may be added to CPU hardware. Related information describing CPU hot add/remove/migration features is described in related U.S. patent application Ser. No. 11/863,563 entitled “Supporting Advanced RAS Features in a Secured Computing System” filed on Sep. 28, 2007.

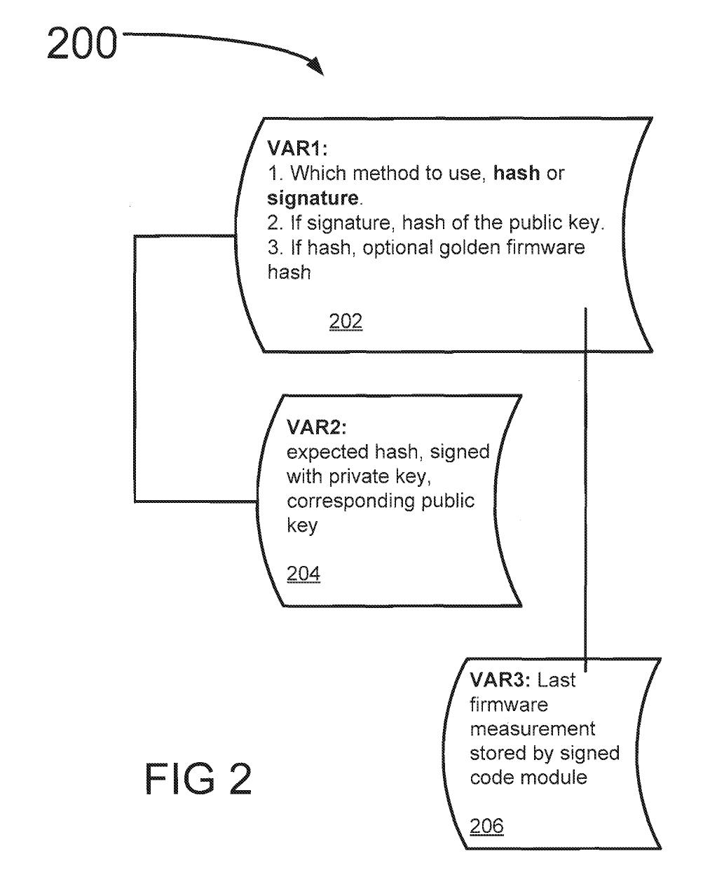

FIG. 2 illustrates a data structure or structures (and/or data storage) 200 according to some embodiments. In some embodiments the data structure 200 includes data structures 202, 204, and/or 206. Data structure 202 holds a value “VAR1”, which is, for example, installed in the TPM by an OEM in the factory. This value “VAR1” indicates which method (hash or signature) will be used. If signature is to be used, “VAR1” also holds a hash of the public key. If hash is to be used, “VAR1” also holds an optional golden firmware hash in some embodiments (for example, a golden BIOS hash). Data structure 204 holds a value “VAR2”, which is, for example, stored in the firmware flash (for example, in the BIOS flash). This value “VAR2” holds an expected hash signed with a private key and a corresponding public key. Data structure 206 holds a value “VAR3”, which is, for example, a last firmware measurement (for example, a last BIOS measurement) stored by the signed code module (for example, ACM and/or Startup ACM) in the TPM.

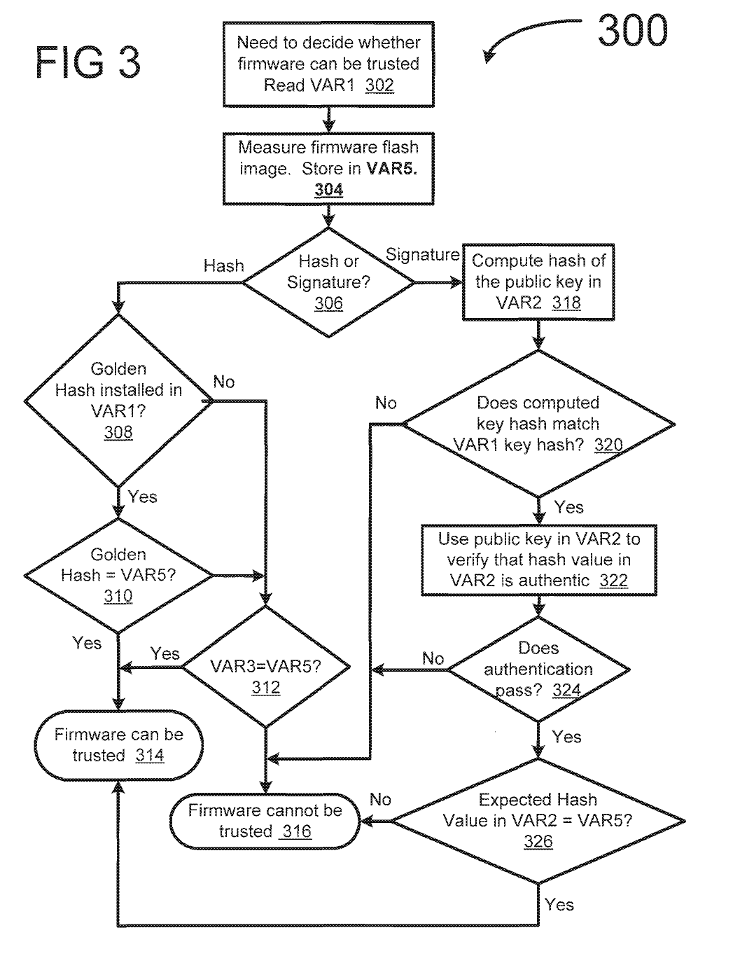

FIG. 3 illustrates a flow 300 according to some embodiments. At 302 a situation has occurred where the signed code module (for example, ACM and/or Startup ACM) needs to decide whether the firmware (for example, the BIOS) can be trusted or not. Then the firmware flash image is measured at 304 and stored in a data structure and/or storage “VAR5”. At 306 a determination is made as to whether to use a hash or a signature. This may be implemented, for example, by reading the value “VAR1” stored in the data structure 202 illustrated in FIG. 2 that identifies whether to use a hash or a signature.

If it is determined at 306 that a hash is to be used, then a determination is made at 308 as to whether a golden hash has been installed in VAR1. If it is determined at 308 that a golden hash has been installed in VAR1, then a determination is made at 310 as to whether the golden hash installed in VAR1 is equal to the value VAR5 stored at 304. If a determination is made at 310 that the golden hash is equal to the value VAR5 stored at 304 then flow moves to 314, which indicates that the firmware (for example, the BIOS) can be trusted. If it is determined at 308 that a golden hash has not been installed in VAR1 or if it is determined at 310 that the golden hash is not equal to VAR5 stored at 304, then a determination is made at 312 as to whether the value VAR3 is equal to the value VAR5 stored at 304. In some embodiments, the value VAR3 is the value stored in the data structure 206 illustrated in FIG. 2 that identifies the last firmware (for example, BIOS) measurement stored by the signed code module (for example, ACM and/or Startup ACM) in the TPM. If a determination is made at 312 that the value VAR3 is equal to VAR 5, then flow moves to 314, which indicates that the firmware (for example, the BIOS) can be trusted. If a determination is made at 312 that the value VAR3 is not equal to VAR 5, then flow moves to 316, which indicates that the firmware (for example, the BIOS) cannot be trusted.

If it is determined at 306 that a signature is to be used, then a hash is computed at 318 of the public key VAR2 (for example, the value VAR2 stored in the data structure 204 in FIG. 2). Then a determination is made at 320 to determine if the key hash computed at 318 matches the hash of the public key stored in VAR1 (for example, the hash of the public key stored in data structure 202 in FIG. 2). If it is determined at 320 that the key hash computed at 318 does not match the hash of the public key, then the key is invalid and flow moves to 316, which indicates that the firmware (for example, the BIOS) cannot be trusted. If it is determined at 320 that the key hash computed at 318 does match the hash of the public key, then the public key stored in VAR2 (for example, the public key stored in data structure 204 in FIG. 2) is used at 322 to verify that the hash value in VAR2 is authentic. Then a determination is made at 324 as to whether the authentication has passed. If the authentication did not pass at 324, then the hash is invalid and flow moves to 316, which indicates that the firmware (for example, the BIOS) cannot be trusted. If the authentication did pass at 324, then a determination is made at 326 as to whether the expected hash value in VAR2 is equal to the value VAR5 stored at 304. If it is determined at 326 that the expected hash value in VAR2 is equal to the value VAR5 stored at 304, then flow moves to 314, which indicates that the firmware (for example, the BIOS) can be trusted. If it is determined at 326 that the expected hash value in VAR2 is not equal to the value VAR5 stored at 304, then flow moves to 316, which indicates that the firmware (for example, the BIOS) cannot be trusted.

Some embodiments have been described herein as relating to firmware policy. For example, in some embodiments steps 318-324 use a signature method in which the firmware policy itself needs to be verified. However, in some embodiments the end goal is verification of the firmware (or, for example, BIOS) itself. It is noted that some embodiments are related to firmware. For example, in some embodiments a hash of the firmware (for example, BIOS firmware module) is computed and compared with a known good value of a firmware hash, not just the hash of the policy structure.

In some embodiments, a signed code module may be used to solve several security policy ownership related problems. For example, an Information Technology (IT) organization of the platform owner may be allowed to control the policy (for example, the firmware policy). This is done, for example, by allowing IT organizations to sign the policy instead of a platform OEM signing the policy.

In some embodiments, trust can be established in the firmware (for example, in the BIOS) before the VMM has examined the boot environment recorded in the TPM. Previous trusted execution technology implementations did not include capability to verify trust in the platform firmware (for example, in the platform BIOS) before it is verified by the VMM in a boot session. Therefore, in previous implementations, for example, a new signed code module would need to be invested in and productized in order to perform memory cleaning, S3 sleep state/exits were slow when trusted execution technology was enabled, and/or CPU hot add RAS features could not be used in conjunction with trusted execution technology. In some embodiments using these inventions one or more or all of these limitations are overcome.

Although some embodiments have been described herein as being implemented by building on existing Intel technology, according to some embodiments implementations using Intel technology is not required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a non-volatile memory to store firmware;
a processor to initiate a code module to verify an integrity of the firmware prior to initiation of a firmware reset vector.

2. The apparatus of claim 1, wherein the code module is to compute a hash of the firmware and to compare the hash with a known good hash of the firmware.

3. The apparatus of claim 2, wherein the known good hash is a hash prepared in advance by the code module.

4. The apparatus of claim 2, wherein the code module is to compute a firmware hash at each boot operation, wherein the known good hash is the hash of the firmware computed and saved at the last boot operation.

5. The apparatus of claim 2, wherein the known good hash is a measurement stored by a system manufacturer.

6. The apparatus of claim 2, wherein the known good hash is a measurement stored by a system administrator.

7. The apparatus of claim 1, wherein the code module is digitally signed and verified by processor hardware before invocation.

8. The apparatus of claim 1, wherein the code module is to verify the integrity prior to a memory cleaning operation.

9. The apparatus of claim 1, wherein the code module is to verify the integrity when an S3 resume operation is to be performed.

10. The apparatus of claim 1, wherein the code module is to verify the integrity when the firmware is brought into a trust domain so as to configure trusted execution technology hardware and/or path that connects trusted execution technology hardware components.

11. The apparatus of claim 1, wherein the code module is to verify the integrity when a processor is to be hot added.

12. A method comprising:
verifying an integrity of firmware stored in a non-volatile memory prior to initiation of a firmware reset vector.

13. The method of claim 12, further comprising computing a hash of the firmware, and comparing the hash with a known good hash of the firmware.

14. The method of claim 13, further comprising of preparing the known good hash in advance.

15. The method of claim 13, further comprising of computing a firmware hash at each boot operation, wherein the known good hash is the hash of the firmware computed and saved at the last boot operation.

16. The method of claim 14, wherein the known good hash is a measurement stored by a system manufacturer.

17. The method of claim 14, wherein the known good hash is a measurement stored by a system administrator.

18. The method of claim 12, further comprising of using a digitally signed key to sign an expected hash value.

19. The method of claim 12, further comprising verifying the integrity prior to a memory cleaning operation.

20. The method of claim 12, further comprising verifying the integrity when an S3 resume operation is to be performed.

21. The method of claim 12, further comprising verifying the integrity when the firmware configures trusted execution technology hardware and/or path that connects trusted execution technology hardware components

22. The method of claim 12, further comprising verifying the integrity when a processor is to be hot added.
